(19) United States
(12) Patent Application Publication
(10) Pub. No.: US 2005/0264477 A1
(43) Pub. Date: Dec. 1, 2005

(54) Plasma display panel driving method

(76) Inventors: Gab-Sick Kim, Suwon-si (KR); Yoon-Hyoung Cho, Suwon-si (KR); Seung-Rok Shin, Suwon-si (KR)

Correspondence Address: CHRISTIE, PARKER & HALE, LLP, PO BOX 7068, PASADENA, CA, 91109-7068, US

(21) Appl. No.: 11/128,902

(22) Filed: May 13, 2005

(30) Foreign Application Priority Data
May 31, 2004 (KR) 10-2004-0038988

(51) Int. Cl. G09G 3/28

(52) U.S. Cl. 345/60

(57) ABSTRACT

In a plasma display panel, one field is divided into a first group of subfields and a second group of subfields. A first subfield of the first group of subfields selects light-emitting cells using a selective write process, and the remaining subfields of the first group of subfields select non-light-emitting cells from the light-emitting cells using a selective erase process. In addition, a first subfield of the second group of subfields selects light-emitting cells using the selective write process, and the remaining subfields of the second group of subfields select non-light-emitting cells from the light-emitting cells using the selective erase process. In addition, a reset operation for initializing all discharge cells is performed in the first subfields of the first and second groups of subfields.

### CROSS REFERENCE TO RELATED APPLICATION

This application claims priority to and the benefit of Korean Patent Application No. 10-2004-0038988 filed on May 31, 2004 in the Korean Intellectual Property Office, the entire content of which is incorporated herein by reference.

### BACKGROUND OF THE INVENTION

1. Field of the Invention

The present invention relates to a driving method for a plasma display panel (PDP).

2. Description of the Related Art

The plasma displays are displays using PDPs that use plasma generated by gas discharge to display characters or images. The PDPs include, according to their size, more than several millions of pixels arranged in the form of a matrix. These PDPs are typically classified into a direct current (DC) type and an alternating current (AC) type according to patterns of waveforms of driving voltages applied thereto and discharge cell structures thereof.

Generally, in an AC type PDP, one field (1TV field) is divided into a plurality of subfields each having its own weight and gray scales are represented by combinations of weights of active (i.e., displayed) ones of the plurality of subfields. Each subfield includes an address period during which discharge cells to be lighted are selected and a sustain period during which the discharge cells selected during the address period are sustained and discharged during a period corresponding to a weight.

One method of performing a sustain discharge operation for all discharge cells after completing an addressing operation for all discharge cells in each subfield involves temporarily separating the address period from the sustain period, which is generally called an address display period separation (ADS) method in the art. This ADS method can be easily implemented, but since the addressing operation is sequentially performed for all discharge cells, some discharge cells to be later addressed may not be addressed due to the lack of priming particles within the discharge cells. Therefore, in order to secure a stable address discharge, it is necessary to increase the width of scan pulses sequentially applied to row electrodes, and hence the length of the address period. As a result, the length of subfields also becomes long, limiting the number of subfields available in one field.

Unlike the ADS method, there is an alternative method of inserting an address pulse of each line between two successive sustain discharge pulses and performing the addressing operation for one line while performing the sustain discharge operation for another line, that is, a method wherein the address period is not separated from the sustain period, which is generally called an address while display (AWD) method.

In the AWD method, a reset pulse requiring a somewhat long time for initialization must be inserted between the address pulse and the sustain discharge pulse, which are successively applied. In other words, a strong reset discharge causes a black screen to be seen brightly, deteriorating a contrast ratio.

In addition, both the ADS method and the AWD method use subfields having different weights for gray scale representation. For example, in the case of subfields having weights of a type of the second power of 2, a so-called false contour is produced when one discharge cell represents a 127 level of gray scale in one frame and a 128 level of gray scale in another frame.

### SUMMARY OF THE INVENTION

In accordance with the present invention a driving method of a plasma display panel is provided which is capable of performing a high speed scan operation, reducing a false contour, and improving a contrast ratio.

In one aspect of the present invention, a driving method involves dividing one field into a plurality of subfields and representing gray scales using the plurality of subfields in a plasma display panel having a plurality of row electrodes for performing a display operation, a plurality of column electrodes intersecting the plurality of row electrodes, and a plurality of discharge cells defined by the plurality of row electrodes and the plurality of column electrodes.

In an exemplary embodiment of the present invention, the plurality of row electrodes are grouped into a plurality of row groups, and one subfield is divided into a plurality of select periods corresponding to the plurality of row groups, respectively. The discharge cells of the plurality of row groups are initialized to a non-light-emitting cell state in a reset period of a first subfield positioned at the head in time of the plurality of subfields. The discharge cells, which will be set to a light-emitting cell state in the discharge cells of a first row group of the plurality of row groups, are write-discharged, and the light-emitting cells are sustain-discharged during a sustain period, in the select period for the first row group of the first subfield. The discharge cells, which will be set to the non-light-emitting cell state in the discharge cells set to the light-emitting cell state of the first row group, are erase-discharged, and the light-emitting cells are sustain-discharged during the sustain period, in the select period for the first row group of a second subfield.

In another exemplary embodiment of the present invention, at least one first subfield positioned at the head in time of the plurality of subfields includes a first address period and a first sustain period. In a plurality of second subfields, the plurality of row electrodes are grouped into a plurality of row groups, the second subfield is divided into a plurality of select periods corresponding to the plurality of row groups, respectively, and each of the plurality of select periods includes a second address period and a second sustain period. Light-emitting cells are selected in the plurality of discharge cells during the first address period, and the light-emitting cells are sustain-discharged during the first sustain period. In the select period for the first row group of the second subfield, light-emitting cells are selected in discharge cells of a first row group of the plurality of row groups during the second address period, and the light-emitting cells are sustain-discharged during the second sustain period.

In yet another exemplary embodiment of the present invention, the plurality of row electrodes are grouped into a plurality of row groups. The discharge cells are initialized in a first subfield positioned at the head in time of the plurality of subfields. Light-emitting cells are set by sequentially performing a first type address discharge for each row group in the first subfield, and the light-emitting cells are sustain-discharged after the first type address discharge of each row group in the first subfield. The light-emitting cells are set by sequentially performing a second type address discharge for each row group in a second subfield of the plurality of subfields, and the light-emitting cells are sustain-discharged after the second type address discharge of each row group in the second subfield. The discharge cells of a non-light-emitting cell state are set to a light-emitting cell state by the first type address discharge, and the discharge cells of the light-emitting cell state are set to the non-light-emitting cell state by the second type address discharge.

In yet another exemplary embodiment of the present invention, light-emitting cells are set for the plurality of row electrodes in a first group of subfields of the plurality of subfield, and the light-emitting cells are sustain-discharged in the first group of subfields. The plurality of row electrodes are grouped into a plurality of row groups and the light-emitting cells are sequentially set for each row group in a second group of subfields of the plurality of subfields. The light-emitting cells are sustain-discharged between a light-emitting cell setting period of each row group and a light-emitting cell setting period of the next row group, in the second group of subfields.

### BRIEF DESCRIPTION OF THE DRAWINGS

FIG. 1 shows a schematic overview of a plasma display according to an exemplary embodiment of the present invention.

FIG. 2 shows a schematic diagram illustrating a driving method a plasma display panel according to a first embodiment of the present invention.

FIG. 3 shows a diagram illustrating a gray scale representation in the driving method of FIG. 2.

FIG. 4 shows a driving waveform diagram of the plasma display panel according to the first embodiment of the present invention.

FIG. 5 shows a schematic diagram illustrating a driving method of a plasma display panel according to a second embodiment of the present invention.

FIG. 6 shows a diagram illustrating a gray scale representation in the driving method of FIG. 5.

FIG. 7 shows a schematic diagram illustrating a driving method of a plasma display panel according to a third embodiment of the present invention.

FIG. 8 shows a diagram illustrating a gray scale representation in the driving method of FIG. 7.

### DETAILED DESCRIPTION

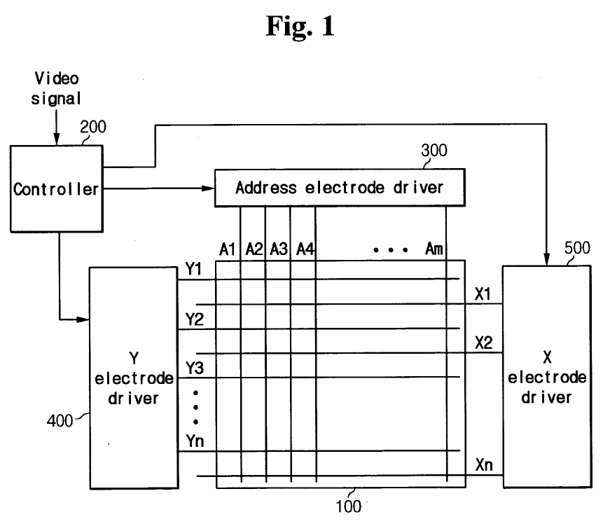

Referring to FIG. 1, a plasma display according to an embodiment of the present invention includes a plasma display panel 100, a controller 200, an address electrode driver 300, a Y electrode driver 400 and a X electrode driver 500.

The plasma display panel 100 includes a plurality of address electrodes (hereinafter, referred to as “A electrodes”) A1 to Am extending in a column direction, and a plurality of sustain electrodes (hereinafter, referred to as “X electrodes”) X1 to Xn and a plurality of scan electrodes (hereinafter, referred to as “Y electrodes”) Y1 to Yn, which are paired, extending in a row direction. Generally, the X electrodes X1 to Xn are formed corresponding to the Y electrodes Y1 to Yn. In addition, the plasma display panel 100 includes a substrate (not shown) on which the X and Y electrodes X1 to Xn and Y1 and Yn are formed and a substrate (not shown) on which the A electrodes A1 to Am are formed. The two substrates are arranged opposite to each other with a discharge space provided therebetween in such a manner that the A electrodes A1 to Am are perpendicular to the Y electrodes Y1 to Yn and the X electrodes Xn to Xn. Discharge spaces at intersections of the A electrodes A1 to Am and the X and Y electrodes X1 to Xn and Y1 to Yn form discharge cells. The present invention is applicable to plasma display panels having other structures to which driving waveforms, which will be described below, are applied.

In the following description, one discharge cell is defined by a pair of X and Y electrodes and one A electrode. In addition, the pair of X and Y electrodes extending in the row direction is referred to as the row electrode and the A electrode is referred to as the column electrode.

The controller 200 receives a video signal from the outside and outputs an address driving control signal, an X electrode driving control signal, and a Y electrode control signal. In addition, the controller 200 divides one field into a plurality of subfields each having its own weight and drives them. The address electrode driver 300, the X electrode driver 400 and the Y electrode driver 500 apply driving voltages to the A electrodes A1 to Am, the X electrodes X1 to Xm and the Y electrodes Y1 to Yn, respectively.

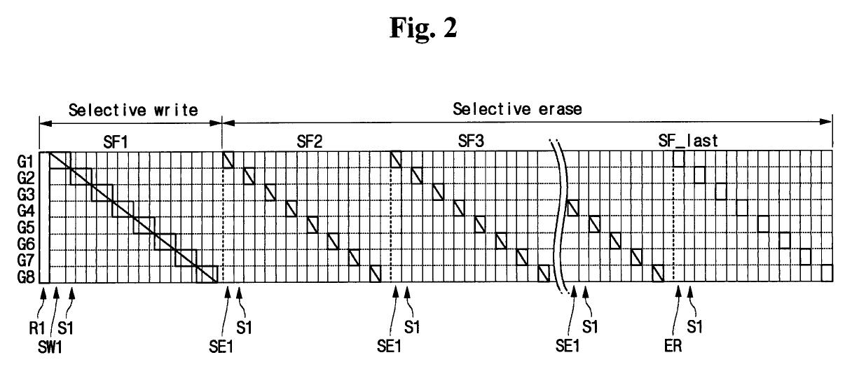

Next, a driving method of the plasma display panel according to a first embodiment of the present invention will be described with reference to FIGS. 2 to 4. In the first embodiment of the present invention, it is assumed that the length of sustain periods following address periods of each row group are equal and these sustain periods have the same length in all subfields.

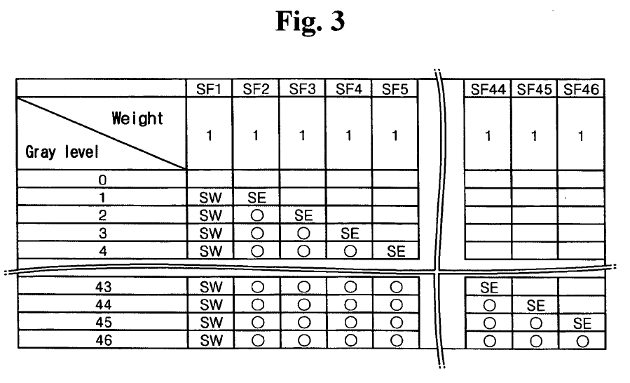

FIG. 2 shows a schematic diagram illustrating a driving method a plasma display panel according to a first embodiment of the present invention, and FIG. 3 shows a diagram illustrating a gray scale representation in the driving method of FIG. 2.

As shown in FIG. 2, it is assumed that one field is divided into a plurality of subfields SF1 to SF_last each having the same weight. In addition, it is assumed that a plurality of row electrodes X1 to Xn and Y1 to Yn is divided into a plurality of row groups, for example, 8 groups in FIG. 2 for explanation convenience. In addition, for the plurality of row groups G1 to G8, first to j^{th} (where, j=n/8) row electrodes are set as a first row group G1, (j+1)^{th} to (2j)^{th} row electrodes are set as a second row group G2, and, in this way, (7j+1)^{th} to n^{th} row electrodes are set as an eighth row group G8.

Generally, a subfield includes an address period during which discharge cells to be light-emitted and discharge cells not to be light-emitted for each subfield are selected from a plurality of discharge cells and a sustain period during which a sustain discharge operation, i.e., a display operation, is performed during a period corresponding to a weight of a subfield in discharge cells selected during the address period. The sustain discharge operation is performed when the sum of a wall voltage set between the X electrode and the Y electrode in the address period and a voltage applied between the X electrode and the Y electrode in the sustain period exceeds a discharge firing voltage, and the voltage applied in the sustain period is set to a voltage lower than the discharge firing voltage.

Processes of selecting one of the light-emitting discharge cell and the non-light-emitting cell in the address period include a selective write process and a selective erase process. The selective write process is a process for selecting a light-emitting discharge cell and forming a wall voltage on the selected light-emitting discharge cell, and the selective erase process is a process for selecting a non-light-emitting discharge cell and erasing a wall voltage, which has been already formed on the selected non-light-emitting discharge cell. In the following description, a state where the light-emitting discharge cell is selected in the address period by the selective write process or the selective erase process is referred to as “a light-emitting cell state”, and a state where the non-light-emitting discharge cell is selected in the address period by the selective write process or the selective erase process is referred to as “a non-light-emitting cell state”.

In the first embodiment of the present invention, in an address period of a first subfield SF1, a discharge cell of the non-light-emitting state is set to the light-emitting cell state by write-discharging the discharge cell to form wall charges on the discharge cell, that is, the selective write process is performed. In address periods of the remaining subfields SF2 to SF_last, discharge cells of the non-light-emitting state are set to the non-light-emitting cell state by erase-discharging the discharge cell to erase wall charges from the discharge cells, that is, the selective erase process is performed. In addition, the address periods are sequentially performed for the plurality of row groups G1 to G8 in the plurality of subfields SF1 to SF_last, and sustain periods having the same length are performed between the address periods. In the following description, the sum of an address period and a sustain period for one row group in each subfield is referred to as “a select period” of the row group, and the sum of sustain periods of all row groups in each subfield is referred to as “a display period” of the subfield. If the plurality of row electrodes consists of 8 row groups G1 to G8 as shown in FIG. 2, the display period is 8 times the sustain period in the select period of one row group.

Next, the driving method according to the first embodiment of the present invention will be described in more detail with reference to FIG. 2.

Firstly, there is a need to initialize all discharge cells in order to prevent discharge cells not selected in the first subfield SF1 from being erroneously discharged in the sustain period and perform the selective write process for discharge cells to be lighted in the address period. Accordingly, the first subfield SF1 has a reset period R1 during which the discharge cells of all row groups G1 to G8 are initialized to be set to the non-light-emitting cell state.

Subsequently, select periods of the first to eighth row groups G1 to G8 are sequentially performed in the first subfield SF1. Light-emitting cells of the discharge cells of the i^{th} row group Gi are selected through write-discharging in an address period SW1 of the select period of the i^{th} row group Gi, and a sustain discharge occurs in discharge cells of the light-emitting cell state of the i^{th} row group Gi in a sustain period S1 of the select period of the i^{th} row group Gi. The sustain discharge also occurs in discharge cells set to the light emitting cell state in each address period SW1 of the first to (i−1)^{th} row groups G1 to Gi−1. In addition, the discharge cells set to the light-emitting cell state in the i^{th} row group Gi are sustain-discharged during the sustain period S1 of each row group before the select period of the i^{th} row group Gi of a second subfield SF2, i.e., during the display period.

Next, the select periods of the first to eighth row group G1 to G8 are sequentially performed in the second subfield SF2. Non-light-emitting cells of the discharge cells set to the light cell state in the first subfield SF1 through the erase discharge are selected in an address period SE1 of the select period of the i^{th} row group G1. In the sustain period S1 of the select period of the i^{th} row group G1, the sustain discharge is performed for discharge cells of the light-emitting cell state (i.e., discharge cells in which the erase discharge does not occur, of the discharge cells selected as the light-emitting cells in the first subfield SF1). The sustain discharge also occurs in discharge cells, set to the light-emitting cell state in the second subfield SF2, of the discharge cells of the first to (i−1)^{th} row groups G1 to Gi−1 and discharge cells, set to the light-emitting cell state in the first subfield SF1, of the discharge cells of the (i+1)^{th} to eighth row groups Gi+1 to G8. In addition, the discharge cells set to the light-emitting cell state in the i^{th} row group Gi are sustain-discharged before the select period of the i^{th} row group Gi of a third subfield SF3, i.e., during the display period.

In this way, the address period and the sustain period of the selective erase process are also sequentially performed for the first to eighth row groups G1 to G8 in the third to last subfields SF3 to SF_last. In addition, the discharge cells, set to the light-emitting cell state through the write-discharge in the first subfield SF1, of the discharge cells of the i^{th} row group maintain the sustain discharge during the display period of each subfield before the discharge cells set to the light-emitting cell state are set to the non-light-emitting cell state through the erase discharge in address periods SE1 of the subsequent subfields SF2 to SF_last. Then, when any discharge cell is set to the non-light-emitting cell state, the discharge cell stops the sustain discharge from a corresponding subfield.

Still referring to FIG. 2, erase periods ER are sequentially formed for the row groups G1 to G8 in the last subfield SF_last. In the last subfield SF_last, the eighth row group G8 is also required to perform the sustain discharge during the display period. However, when the eighth row group G8 performs the sustain discharge during the display period, the sustain discharge during more than the display period is performed for the previous row groups G1 to G7. Accordingly, in the last subfield SF8, erase processes are sequentially performed for the row groups G1 to G8 after the end of the display period. These erase processes may be performed for all discharge cells of a corresponding row group, unlike the selective erase process as described above.

Next, a method of representing gray scales using the driving method of FIG. 2 will be described with reference to FIG. 3. In FIG. 3, “SW” represents that a discharge cell is set to the light-emitting cell state through the write discharge occurring in a corresponding subfield, and “SE” represents that a discharge cell is set to the non-light-emitting cell state through the erase discharge occurring in a corresponding subfield. Also, “◯” represents that a discharge cell is the light-emitting cell state in a subfield in which “◯” is shown. In addition, as described earlier, since the length of the display periods of all subfields is the same, a gray scale when the sustain discharge occurs in only one subfield is represented by 1.

First, when the non-light-emitting cell state is set in the address period SW1 of the first subfield SF1, a 0 level of gray scale is represented since the sustain discharge does not occur in the sustain period, and also, the sustain discharge does not occur in the subsequent subfields SF2 to SF_last.

In addition, when the light-emitting cell state is set through the write discharge occurring in the address period SW1 of the first subfield SF1, a 1 level of gray scale can be represented as sustain discharge occurs in the display period of the subfield SF1. Next, when the non-light-emitting cell state is set through the erase discharge occurring in the second subfield SF2, a 1 level of gray scale is represented as the sustain discharge does not occur from the second subfield SF2. In addition, since the light-emitting cell state remains if the erase discharge does not occur in the second subfield SF2, a 2 level of gray scale is represented as the sustain discharge also occurs in the sustain period of the second subfield SF2.

In this way, an (i−1) level of gray scale is represented as the discharge cells set to the light-emitting cell state through the write discharge occurring in the first subfield SF1 and then set to the non-light-emitting cell state through the erase discharge in the i^{th} subfield SFi are sustained-discharged in the first to (i−1)^{th} subfields SF1 to SFi−1.

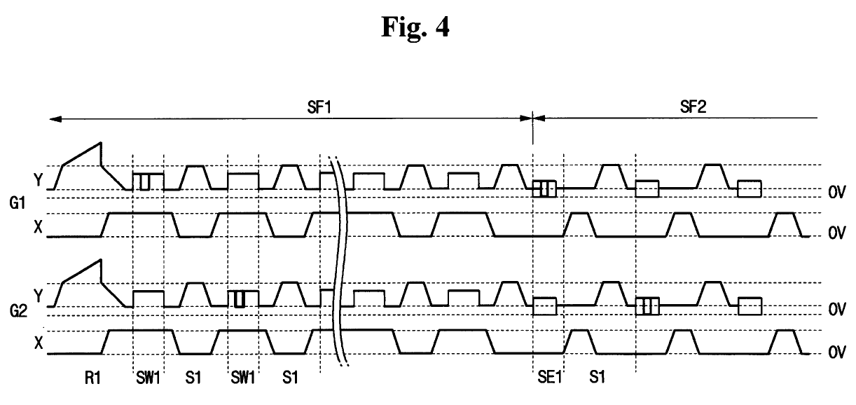

Next, driving waveforms for use with the driving method of the plasma display panel according to the first embodiment of the present invention will be described in detail with reference to FIG. 4.

FIG. 4 shows a driving waveform diagram of the plasma display panel according to the first embodiment of the present invention. For the purpose of convenience of explanation, only the first and second row groups G1 and G2 and the first and second subfields SF1 and SF2 are partially shown, and illustration of the A electrode is omitted. In addition, since the driving waveform shown in FIG. 4 is a driving waveform generally used for the plasma display panel, detailed explanation thereof will be omitted.

As shown in FIG. 4, first, wall charges are formed in the discharge cells by causing the reset discharge by gradually increasing voltages of the Y electrodes of both row groups G1 and G2 in the reset period R1 of the first subfield SF1 under a state where the X electrodes are biased to a ground (0V) voltage. Next, the discharge cells are initialized by erasing the wall charges formed by the reset discharge by gradually decreasing the voltages of the Y electrodes of the row groups G1 and G2 under a state where the X electrodes are biased to a positive voltage.

Subsequently, under the state where the X electrodes are biased to the positive voltage, a scan pulse (the ground, or 0V, voltage in FIG. 4) is sequentially applied to the plurality of Y electrodes of the first row group G1, and, although not shown, a positive address voltage is applied to the A electrodes of discharge cells to be light-emitted of the discharge cells formed by the Y electrode to which the scan pulse is applied. Then, the write discharge occurs in the discharge cells to which a voltage of the scan pulse and the address voltage are applied, thereby forming wall charges in the X electrode and the Y electrode. The scan pulse is not applied to Y electrodes of the second to eighth row groups G2 to G8.

Next, a sustain discharge pulse is applied to the Y electrodes in order to discharge the discharge cells of the light-emitting cell state, and then, the sustain discharge pulse is applied to the X electrodes in order to discharge the discharge cells. Then, the scan pulse is sequentially applied to the Y electrodes of the second row group G2 while the sustain discharge pulse is applied to the X electrodes, and accordingly, the address period of the second group G2 is performed. In this manner, the select period for the first to eighth row groups G1 to G8 is performed in the first subfield SF1.

Next, a scan pulse having a negative voltage is sequentially applied to the Y electrodes of the first row group G1 in the address period SE1 of the second subfield SF, and then, a positive voltage (not shown) is applied to the A electrodes of the discharge cells set to the non-light-emitting cell state. The width of the scan pulse is narrow such that wall charges are not formed but erased by discharging. When a negative voltage and a positive voltage are applied to the Y electrodes and A electrodes of the discharge cells of the light-emitting cell state having the wall voltage formed by the sustain discharge pulse applied to the Y electrodes, respectively, the wall charges are erased through discharge occurring due to the wall voltage and the applied voltages, which results in the non-light-emitting cell state. Subsequently, the sustain discharge pulse is applied to the X electrodes and the Y electrodes, alternately. This process is sequentially performed for the second to eighth row groups G2 to G8.

In this manner, in the first embodiment of the present invention, since the address periods are formed between the sustain periods of the row groups, and accordingly, priming particles formed in the sustain periods can be sufficiently utilized in the address periods, a high speed scan with the scan pulse having a narrow width can be achieved. In addition, in the address period in the selective erase process, the width of the scan pulse can be further narrowed such that the wall charges are erased. In addition, since the gradually increasing and decreasing voltages are used in the reset period, a strong discharge does not occur in the reset period. In addition, since the reset period is one time performed for all row groups during one field, the contrast ratio can be increased.

For example, it is assumed that the width of the scan pulse in the selective write process is 1.5 μs the width of the scan pulse in the selective erase process is 1.0 μs, the length of the reset period is 350 μs, and 20 sustain discharge pulses are accommodated in one subfield. Under this circumstance, if 480 row electrodes are driven, the first subfield SF1 requires 1170 μs (=350+1.5×480+20×5) and each of the remaining subfields SF2 to SF_last requires 1170 μs (=1.0×480+20×5). Accordingly, a total of 46 subfields can be accommodated in one subfield (16.6 ms), and 47 levels of gray scale can be represented. In this case, applying a 2×2 dithering technique, 188 (=47×4) levels of gray scale can be represented, and moreover, applying a 4-bit error diffusion technique, 3008 (=188×16) levels of gray scale can be represented.

In addition, in the first embodiment of the present invention, there occurs no false contour since all subfields have the same weight and the gray scales are represented by the sum of display periods of the successive subfields starting from the first subfield.

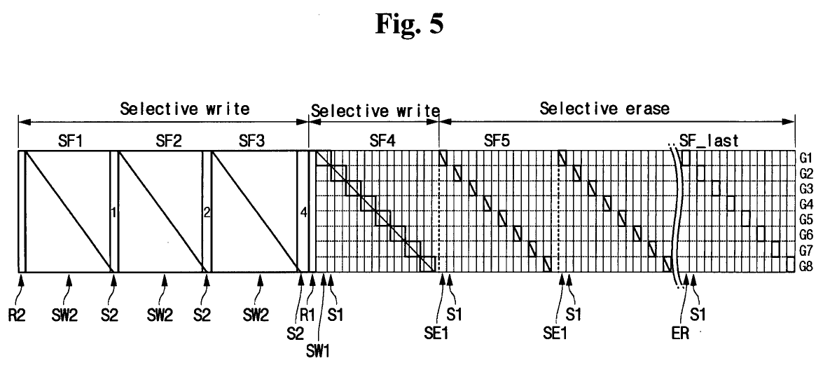

In the first embodiment of the present invention as described above, since all subfields have the same length and the gray scales are represented by the subfields successively lighted starting from the first subfield, there is a limitation to the number of gray scales which can be represented by only subfields. Hereinafter, a method of increasing the number of gray scales which can be represented by only subfields will be described in detail with reference to FIGS. 5 to 8.

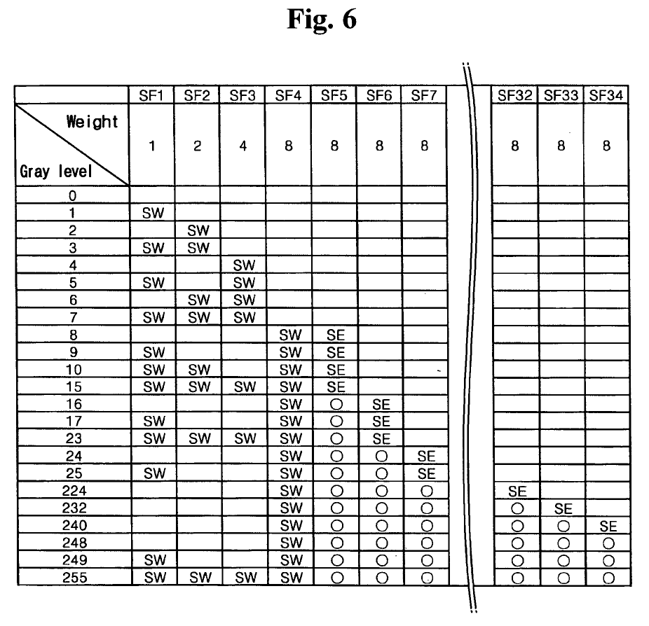

First, a driving method of a plasma display panel according to a second embodiment of the present invention will be described with reference to FIGS. 5 and 6.

FIG. 5 shows a schematic diagram illustrating a driving method of a plasma display panel according to the second embodiment of the present invention, and FIG. 6 shows a diagram illustrating a gray scale representation in the driving method of FIG. 5.

As shown in FIG. 5, in the second embodiment of the present invention, the plurality of subfields SF1 to SF_last is grouped into two groups of subfields depending on grouping of row electrodes. First, a first group of subfields consists of at least one subfield positioned at the head in time. In FIG. 5, it is assumed that the first group of subfields consists of the first to third subfields SF1 to SF3. In addition, a second group of subfields consists of the remaining subfields SF4 to SF_last.

Each subfield in the first group of subfields SF1 to SF3 has an address period SW2 and sustain period S2 of the selective write process. In each address period SW2, write discharge is sequentially performed for the discharge cells of all row electrodes and discharge cells to be set to the light-emitting cell state are selected. In addition, in each sustain period S2, the sustain discharge is performed for the discharge cells set to the light-emitting cell state in the address period SW2 of a corresponding subfield.

In addition, each subfield SF1 to SF3 has a reset period during which discharge cells are initialized before the address period SW2, and the first subfield SF1 positioned at the head in time in one field has a main reset period R2 during which all discharge cells are initialized. In addition, the second and third subfields SF2 and SF3 have respective sub-reset periods (not shown) during which an initialization operation is performed for only discharge cells in which the sustain discharge occurs in the preceding subfields SF1 and SF2, respectively, i.e., only discharge cells of the light-emitting cell state.

In this manner, in the first group of subfields SF1 to SF3, the sustain discharge can be selectively performed in each subfield for the discharge cells. If the relative length (i.e., weight) of sustain periods of the first to third subfields SF1 to SF3 is 1, 2 and 4, respectively, 8 kinds of gray scales (0 to 7 levels of gray scale) can be represented in the first group of subfields SF1 to SF3.

Next, each subfield in the second group of subfields SF4 to SF_last has the same structure as the subfields SF1 to SF_last described in connection with the first embodiment. That is, the address period and the sustain period are performed for the plurality of row groups G1 to G8 into which the plurality of row electrodes are grouped.

More specifically, a first subfield SF4 of the second group of subfields has the reset period R1 like the subfield SF1 in the first embodiment, the select period of each row group Gi has the address period SW1 of the selective write process and the sustain period S1. In addition, the select period of each row group Gi in the remaining subfields SF5 to SF_last of the second group of subfields has the address period SE1 of the selective erase process and the sustain period Si like the select period of each row group Gi in the subfields SF2 to SF_last in the first embodiment. The last subfield SF_last has the erase period ER like the last subfield SF_last in the first embodiment.

In addition, display periods, each of which is the sum of sustain periods S1 of subfields in the second group of subfields, have the same length, and also, are equal to the sum of a total of lengths of the sustain periods S2 of the subfields SF1 to SF3 of the first group of subfields and the length of the sustain period S2 of the first subfield SF1. That is, each subfield of the second group of subfields has the display period during which the number (8) of gray scales more by one than the maximum number (7) of gray scales which can be represented in the first group of subfields SF1 to SF3 can be represented.

Thus, in the second group of subfields SF4 to SF_last, the gray scales can be represented by the sum of display periods of successive subfields starting from the fourth subfield SF4. In addition, the gray scales within one field can be represented by the sum of the gray scales represented in the first group of subfields SF1 to SF3 and the gray scales represented in the second group of subfields SF4 to SF_last. Now, a method of such a gray scale representation will be described in detail with reference to FIG. 6.

In FIG. 6, “SW” represents that a discharge cell is set to the light-emitting cell state through the write discharge occurring in a corresponding subfield, and “SE” represents that a discharge cell is set to the non-light-emitting cell state through the erase discharge occurring in a corresponding subfield. Also, “◯” represents that a discharge cell is the light-emitting cell state in a subfield in which “◯” is shown.

Referring to FIGS. 6, 0 to 7 levels of gray scales are represented by a combination of subfields lighted in the first group of subfields SF1 to SF3. In addition, levels of gray scales corresponding to the integral times of 8 are represented by subfields successively lighted in the second group of subfields SF4 to SF_last, and more than 8^{th} levels of gray scales which are not the integral times of 8 are represented by a combination of the first group of subfields SF1 to SF3 and the second group of subfields SF4 to SF_last.

For example, 8N (where, N is an integer larger than 1) levels of gray scales are represented by only the second group of subfields. That is, 8N levels of gray scales are represented when the non-light-emitting cell state is set through the erase discharge in an (N+1)^{th} subfield SFN+4 of the second group of subfields after the light-emitting cell state is set at the fourth subfield SF4 through the write discharge. In this case, when the light-emitting cell state is set at the first and third subfields SF1 and SF3, 5 levels of gray scales are represented in the first group of subfields. Accordingly, a total of (8N+5) levels of gray scales are represented in the first and second groups of subfields.

That is, in the second embodiment, when the total number of subfields in the second group of subfields SF4 to SF34 is 31 and the total number of subfields in the first group of subfields SF1 to SF3 is 3, 0 to 255 levels of gray scales can be represented. Accordingly, the number of subfields can be further reduced as compared to the first embodiment.

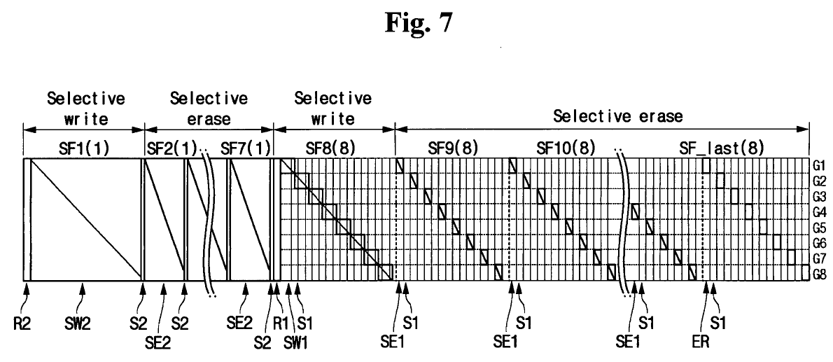

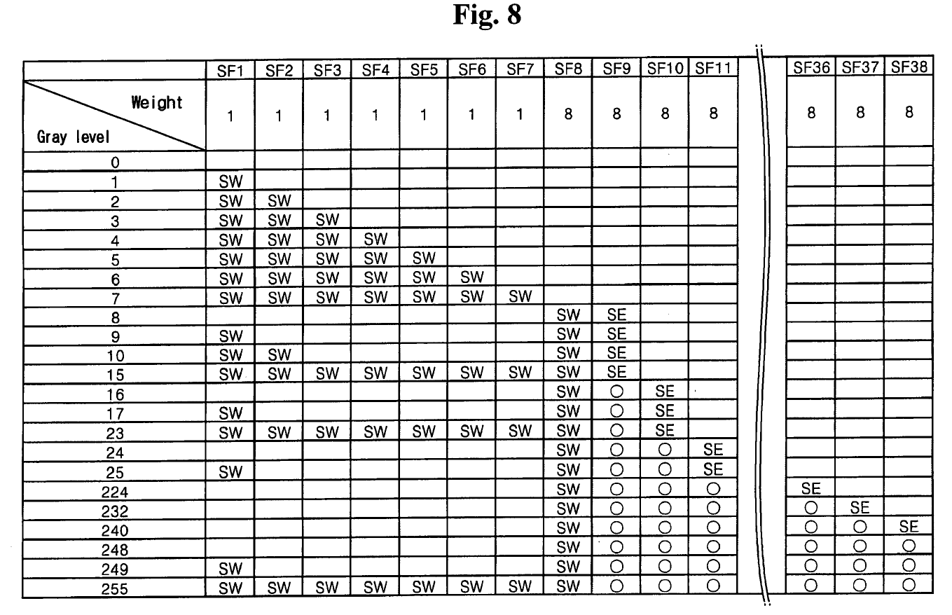

Next, a driving method of a plasma display panel according to a third embodiment of the present invention will be described with reference to FIGS. 7 and 8.

FIG. 7 shows a schematic diagram illustrating a driving method of a plasma display panel according to the third embodiment of the present invention, and FIG. 8 shows a diagram illustrating a gray scale representation in the driving method of FIG. 7.

As shown in FIG. 7, in the third embodiment of the present invention, the plurality of subfields SF1 to SF_last is grouped into two groups of subfields depending on the grouping of row electrodes. First, a first group of subfields consists of at least one subfield positioned at the head in time. In FIG. 7, it is assumed that the first group of subfields consists of the first to seventh subfields SF1 to SF7. In addition, a second group of subfields consists of the remaining subfields SF8 to SF_last.

Each subfield in the first group of subfields SF1 to SF7 has an address period and sustain period. The selective write process is performed for the address period SW2 of the subfield SF1 positioned at the head in time in the first group of subfields, and the selective erase process is performed for the address periods SE2 of the remaining subfields SF2 to SF7. In addition, the sustain periods S2 in the subfields SF1 to SF7 have the same length. In addition, the first subfield SF1 has the reset period R2 during which all discharge cells are initialized before the address period SW2.

In the address period SW2 of the first subfield SF1, discharge cells to be set to the light-emitting cell state of discharge cells of all row electrodes are set to the light-emitting cell state through the write discharge. In addition, in the sustain period S2, the sustain discharge is performed for discharge cells set to the light-emitting cell state in the address period SW2.

Next, in the address period SE2 of the second subfield SF2, discharge cells to be set to the non-light-emitting cell state of discharge cells of the light-emitting cell state in the first subfield SF1 are set to the non-light-emitting cell state through the erase discharge. Subsequently, in the sustain period S2, the sustain discharge is performed for discharge cells set to the light-emitting cell state in the address period SE2 of a corresponding subfield. In this way, the address period SE2 and the sustain period S2 of the selective erase process are also performed for discharge cells of the light-emitting cell state in the third to seventh subfields SF3 to SF7. In addition, the discharge cells set to the light-emitting cell state through the write discharge in the first subfield SF1 maintain the sustain discharge during the sustain period S2 of each subfield before the discharge cells set to the light-emitting cell state are set to the non-light-emitting cell state through the erase discharge in the address periods SE2 of the subsequent subfields SF2 to SF7. Then, when any discharge cell is set to the non-light-emitting cell state, the discharge cell stops the sustain discharge from a corresponding subfield. In this manner, 0 to 7 levels of gray scales can be represented in the first group of subfields.

Next, each subfield in the second group of subfields SF8 to SF_last has the same structure as the subfields SF1 to SF_last described in connection with the first embodiment. That is, the address period and the sustain period are performed for the plurality of row groups G1 to G8 into which the plurality of row electrodes are grouped.

More specifically, a first subfield SF8 of the second group of subfields has the reset period R1 like the subfield SF1 in the first embodiment, the select period of each row group Gi has the address period SW1 of the selective write process and the sustain period S1. In addition, the select period of each row group Gi in the remaining subfields SF9 to SF_last of the second group of subfields has the address period SE1 of the selective erase process and the sustain period S1 like the select period of each row group Gi in the subfields SF2 to SF_last in the first embodiment. The last subfield SF_last has the erase period ER like the last subfield SF_last in the first embodiment.

In addition, display periods, each of which is the sum of sustain periods S1 of subfields in the second group of subfields, have the same length, and also, are equal to the sum of a total of lengths of the sustain periods S2 of the subfields SF1 to SF7 of the first group of subfields and the length of the sustain period S2 of the first subfield SF1. That is, each subfield of the second group of subfields has the display period during which the number (8) of gray scales more by one than the maximum number (7) of gray scales which can be represented in the first group of subfields SF1 to SF7 can be represented.

Next, the gray scale representation in the driving method of FIG. 7 will be described in detail with reference to FIG. 8.

Referring to FIGS. 8, 0 to 7 levels of gray scales are represented by the number of subfields lighted in the first group of subfields SF1 to SF7. In addition, levels of gray scales corresponding to the integral times of 8 are represented by the number of subfields successively lighted in the second group of subfields SF8 to SF_last, and more than 8^{th} levels of gray scales which are not the integral times of 8 are represented by a combination of the first group of subfields SF1 to SF7 and the second group of subfields SF8 to SF_last. Therefore, in the third embodiment of the present invention, when the number of subfields in the first group of subfields SF1 to SF7 is 7 and the number of subfields in the second group of subfields SF8 to SF38 is 31, 0 to 255 levels of gray scales can be represented.

Since detailed driving waveforms in the driving methods according to the second and third embodiments as described above can be easily understood by those skilled in the art from the driving waveform of the first embodiment, detailed explanation thereof will be omitted. In addition, the number of row groups and the number of subfields exemplified in the above embodiments may be modified in various ways.

As described above, according to the present invention, since the gray scales can be represented by the number of subfields successively lighted without using subfields having large weights, the problem of false contour can be overcome. In addition, since the addressing operation is performed for each row group after the sustain period, priming particles produced during the sustain period can be used for the address discharge, thus reducing the width of the scan pulse. In addition, since the width of the scan pulse can be further reduced by using the address period of the selective erase process, it is possible to achieve a high speed scan.

While this invention has been described in connection with certain exemplary embodiments, it is to be understood that the invention is not limited to the disclosed embodiments, but, on the contrary, is intended to cover various modifications and equivalent arrangements included within the spirit and scope of the appended claims.

1. A driving method for dividing one field into a plurality of subfields and representing gray scales using the plurality of subfields in a plasma display panel having a plurality of row electrodes for performing a display operation, a plurality of column electrodes intersecting the plurality of row electrodes, and a plurality of discharge cells defined by the plurality of row electrodes and the plurality of column electrodes, the driving method comprising:
grouping the plurality of row electrodes into a plurality of row groups, and dividing one subfield into a plurality of select periods corresponding to the plurality of row groups, respectively;
initializing the discharge cells of the plurality of row groups to a non-light-emitting cell state in a reset period of a first subfield positioned at the head in time of the plurality of subfields;
write-discharging the discharge cells which will be set to a light-emitting cell state in the discharge cells of a first row group of the plurality of row groups, and sustain-discharging the light-emitting cells during a sustain period, in the select period for the first row group of the first subfield; and
erase-discharging discharge cells which will be set to the non-light-emitting cell state in the discharge cells set to the light-emitting cell state of the first row group, and sustain-discharging the light-emitting cells during the sustain period, in the select period for the first row group of a second subfield.

2. The driving method of claim 1, further comprising:
write-discharging the discharge cells which will be set to the light-emitting cell state in the discharge cells of a second row group of the plurality of row groups, and sustain-discharging the light-emitting cells during the sustain period, in the select period for the second row group after the select period for the first row group of the first subfield; and
erase-discharging the discharge cells which will be set to the non-light-emitting cell state in the discharge cells set to the light-emitting cell state of the second row group, and sustain-discharging the light-emitting cells during the sustain period, in the select period for the second row group of the second subfield.

3. The driving method of claim 2, wherein the light-emitting cells of the first row group are sustain-discharged in the sustain period of the select period for the second row group.

4. The driving method of claim 3, wherein, in each subfield, the length of the sustain period of the select period for the first row group is equal to the length of the sustain period of the select period for the second row group.

5. The driving method of claim 4, wherein the length of the sustain period of the first subfield is equal to the length of the sustain period of the second subfield.

6. The driving method of claim 1, further comprising:
setting the discharge cells of the light-emitting cell state of the first row group to the non-light-emitting cell state after a preset period elapses from the select period for the first row group, in a third subfield positioned at the end in time of the plurality of subfields.

7. The driving method of claim 6, wherein the sum of the select period for the first row group and the preset period corresponds to the sum of a plurality of select periods of the third subfield.

8. The driving method of claim 1, wherein (n-1) levels of gray scales are represented when the discharge cell is set to the non-light-emitting cell state in an n^{th} subfield in time of the plurality of subfields after the discharge cell is set to the light-emitting cell state in the first subfield.

9. A driving method for dividing one field into a plurality of subfields and representing gray scales using the plurality of subfields in a plasma display panel having a plurality of row electrodes for performing a display operation, a plurality of column electrodes intersecting the plurality of row electrodes, and a plurality of discharge cells defined by the plurality of row electrodes and the plurality of column electrodes, the driving method comprising:
positioning at least one first subfield at a head in time of the plurality of subfields the at least one first subfield including a first address period and a first sustain period,
in a plurality of second subfields,
grouping the plurality of row electrodes into a plurality of row groups, and
dividing a second subfield into a plurality of select periods corresponding to the plurality of row groups, respectively, each of the plurality of select periods including a second address period and a second sustain period;
selecting light-emitting cells in the plurality of discharge cells during the first address period, and sustain-discharging the light-emitting cells during the first sustain period; and
selecting light-emitting cells in discharge cells of a first row group of the plurality of row groups during the second address period, and sustain-discharging the light-emitting cells during the second sustain period, in the select period for the first row group of the second subfield.

10. The driving method of claim 9, further comprising initializing the plurality of discharge cells to a non-light-emitting cell state during a first reset period before the first address period of the at least one first subfield,
wherein discharge cells to be set to a light-emitting cell state in the plurality of discharge cells are write-discharged during the first address period of the at least one first subfield.

11. The driving method of claim 10, wherein the first sustain period of the at least one first subfield has a respective weight, and
gray scales in the first subfield are represented by the sum of weights of the first sustain period of the first subfield during which the discharge cell is set to the light-emitting cell state.

12. The driving method of claim 9, wherein the at least one first subfield includes a third subfield positioned at the head in time and at least one fourth subfield, and the third subfield further includes a first reset period before the first address period, the driving method further comprising:
initializing the plurality of discharge cells to a non-light-emitting cell state during the first reset period, ‘wherein discharge cells to be set to a light-emitting cell state in the plurality of discharge cells are write-discharged during the first address period of the third subfield.

13. The driving method of claim 12, wherein, during the first address period of the fourth subfield, the discharge cells to be set to a non-light-emitting cell state among the discharge cells of the light-emitting cell state in the previous subfield are erase-discharged.

14. The driving method of claim 13, wherein the first sustain periods of the at least one first subfield have a same weight, and
(n−1) levels of gray scales are represented in the at least one first subfield when the discharge cell is set to the non-light-emitting cell state in an n^{th} subfield in time from the third subfield after the discharge cell is set to the light-emitting cell state in the third subfield.

15. The driving method of claim 9, wherein the plurality of second subfields includes a fifth subfield positioned at the head in time and a plurality of sixth subfields, the driving method further comprising:
initializing the discharge cells of the plurality of row groups to the non-light-emitting cell state during a reset period of the fifth subfield;
write-discharging the discharge cells which will be set to the light-emitting cell state in the discharge cells of the first row group during the second address period, and sustain-discharging the light-emitting cells during the second sustain period, in the select period for the first row group of the fifth subfield; and
erase-discharging the discharge cells which will be set to the non-light-emitting cell state in the discharge cells set to the light-emitting cell state of the first row group during the address period, and sustain-discharging the light-emitting cells during the second sustain period, in the select period for the first row group of the sixth subfield.

16. The driving method of claim 15, further comprising:
write-discharging the discharge cells which will be set to the light-emitting cell state in the discharge cells of a second row group of the plurality row groups during the second address, and sustain-discharging the light-emitting cells during the second sustain period, in a select period for the second row group after the select period for the first row group of the fifth subfield; and
erase-discharging the discharge cells which will be set to the non-light-emitting cell state in the discharge cells set to the light-emitting cell state of the second row group during the second address period, and sustain-discharging the light-emitting cells during the second sustain period, in the select period for the second row group of the sixth subfield.

17. The driving method of claim 16, wherein the light-emitting cells in the first row group are sustain-discharged in the second sustain period of the select period for the second row group.

18. The driving method of claim 17, wherein the length of the second sustain period of the select period for the first row group of the second subfield is equal to the length of the second sustain period of the select period for the second row group.

19. The driving method of claim 15, further comprising:
setting the discharge cells of the light-emitting cell state of the first row group to the non-light-emitting cell state after a preset period elapses from the select period for the first row group, in a last subfield positioned at the end in time of the plurality of sixth subfields.

20. The driving method of claim 19, wherein the sum of the select period for the first row group and the preset period corresponds to the sum of a plurality of select periods of the last subfield.

21. The driving method of claim 15, wherein (m−1) levels of gray scales are represented in the plurality of second subfields when the discharge cell is set to the non-light-emitting cell state in an m^{th} subfield in time from the second subfield after the discharge cell is set to the light-emitting cell state in the fifth subfield, and
wherein gray scales in one field are represented by the sum of gray scales represented in the first subfield and gray scales represented in the second subfield.

22. A driving method for dividing one field into a plurality of subfields and representing gray scales using the plurality of subfields in a plasma display panel having a plurality of row electrodes for performing a display operation, a plurality of column electrodes intersecting the plurality of row electrodes, and a plurality of discharge cells defined by the plurality of row electrodes and the plurality of column electrodes, the driving method comprising:
grouping the plurality of row electrodes into a plurality of row groups;
initializing the discharge cells in a first subfield positioned at the head in time of the plurality of subfields;
setting light-emitting cells by sequentially performing a first type address discharge for each row group in the first subfield;
sustain-discharging the light-emitting cells after the first type address discharge of each row group in the first subfield;
setting the light-emitting cells by sequentially performing a second type address discharge for each row group in a second subfield of the plurality of subfields; and
sustain-discharging the light-emitting cells after the second type address discharge of each row group in the second subfield,
wherein the discharge cells of a non-light-emitting cell state are set to a light-emitting cell state by the first type address discharge, and the discharge cells of the light-emitting cell state are set to the non-light-emitting cell state by the second type address discharge.

23. A driving method for dividing one field into a plurality of subfields and representing gray scales using the plurality of subfields in a plasma display panel having a plurality of row electrodes for performing a display operation, a plurality of column electrodes intersecting the plurality of row electrodes, and a plurality of discharge cells defined by the plurality of row electrodes and the plurality of column electrodes, the driving method comprising:
setting light-emitting cells for the plurality of row electrodes in a first group of subfields of the plurality of subfields;
sustain-discharging the light-emitting cells in the first group of subfields;
grouping the plurality of row electrodes into a plurality of row groups and sequentially setting the light-emitting cells for each row group in a second group of subfields of the plurality of subfields; and
sustain-discharging the light-emitting cells between a light-emitting cell setting period of each row group and a light-emitting cell setting period of the next row group, in the second group of subfields.

24. The driving method of claim 23, wherein the second group of subfields includes a subfield in which a first type address discharge is performed and a subfield in which a second type address discharge is performed, and
the discharge cells of a non-light-emitting cell state are set to a light-emitting cell state by the first type address discharge, and discharge cells of the light-emitting cell state are set to the non-light-emitting cell state by the second type address discharge.

25. The driving method of claim 23, wherein the first group of subfields includes a subfield in which a first type address discharge is performed, and
the discharge cells of a non-light-emitting cell state are set to a light-emitting cell state by the first type address discharge.

26. The driving method of claim 25, wherein the first group of subfields further includes a subfield in which a second type address discharge is performed, and
the discharge cells of the light-emitting cell state are set to the non-light-emitting cell state by the second type address discharge.

27. The driving method of claim 24, wherein the subfield in which the first type address discharge is performed is positioned at the head in time in each group of subfields.
